(19) United States
(12) Patent Application Publication
(10) Pub. No.: US 2011/0209892 A1
(43) Pub. Date: Sep. 1, 2011

(54) COAXIAL CABLE

(75) Inventors: Stefan Metz, Goldach (CH); Stefan Schaelle, St. Gallen (CH)

(73) Assignee: Huber+Suhner AG, Herisau (CH)

(21) Appl. No.: 12/998,512

(22) PCT Filed: Oct. 20, 2009
(86) PCT No.: PCT/EP2009/063757

§ 371 Date: Apr. 28, 2011

(30) Foreign Application Priority Data
Oct. 30, 2008 (CH) 01701/08

(51) Int. Cl. H01B 7/18

(52) U.S. Cl. 174/102 R

(57) ABSTRACT

The invention relates to a coaxial cable (10) comprising a central inner conductor (11) that is concentrically surrounded by an outer conductor (12) at a specified distance, wherein the intermediate space between the inner conductor (11) and outer conductor (12) is filled with a dielectric (13). A coaxial cable having especially good mechanical and electrical properties is achieved by the dielectric (13) comprising a plurality of hollow fibers (14, 15, 19) that extend in the longitudinal direction of the cable and are composed of a glass, and by at least the inner conductor (11) having a thermal expansion coefficient that is matched to the dielectric (13) with regard to a least possible temperature-related phase change in the coaxial cable (10).

### BACKGROUND OF THE INVENTION

1. Field of the Invention

Coaxial cables have a central inner conductor, which is concentrically surrounded by an outer conductor at a specified distance. The intermediate space between the central inner conductor and the concentric outer conductor is filled with a dielectric. In demanding applications, such as for example in the case of satellite technology in space, of particular significance for coaxial cables along with their suitability for extremely high frequencies in the GHz range are especially a low linear attenuation (in dB/m) and a linear dependence, and/or dependence approaching zero, of the phase shift on the temperature over a great temperature range of, for example, −55° C. to +125° C.

A very low attenuation can be achieved, for example, by the intermediate space between the central inner conductor and the outer conductor being filled as completely as possible with air (relative dielectric constant ∈ᵣ=1). On the other hand, in many cases the dielectric also undertakes the task of stabilizing and fixing the central inner conductor in the center, in order that the concentric structure of the cable is retained even when the cable is bent or twisted.

A high air content in the intermediate space or dielectric can be achieved in various ways:

1. By localized spacers or spacing elements which support and fix the inner conductor on the outer conductor (see, for example, EP-A2-0 899 750 or U.S. Pat. No. 5,742,002).

2. By expanded or porous material of a low density (see, for example, DE-A1-34 15 746 or WO-A1-2007/147271 with further references). Known technologies for this are paste extrusion, melt extrusion, powder sintering or plastic wrapping

3. By tightly packed bundles of tubes running in the longitudinal direction of the cable.

Variant (1) is highly complex to produce and—especially in the case of small cable diameters—can only be realized with difficulty.

Variant (2) is used in a wide variety of forms, but is restricted either in porosity or in mechanical strength.

With respect to variant (3) of the above enumeration, a wide variety of solution proposals have been made in the past:

2. Discussion of Related Art

The document DE-A1-1 440 771 describes a coaxial cable, in particular a method for producing such a cable, in which tubes are laid as spacing elements in one layer around the inner conductor in the longitudinal direction, parallel to the central axis of the cable. The tubes have relatively thin walls, so that the volume between the inner conductor and the outer conductor or jacket is merely filled with air, or at least with a gas. The tubes consist of a foam plastic or elastomer. “Tubes” are understood here as meaning both filled and unfilled tubes and forms of rod, irrespective of whether or not they are hollow. The tubes thus defined may also be produced from glass fibers impregnated or reinforced with various materials, which also contain a reinforcement of silicone or silicone rubber. The same also applies to the related document GB-909,343.

The document DE-B-1 059 522 discloses a coaxial cable in which the conductors are supported against one another and insulated from one another by means of one or more tubular insulating elements. The insulating elements are wound in one layer helically around the inner conductor to be insulated or arranged parallel to the inner conductor. The insulating elements are of a two-part form, comprising an inner element with a helical slit to improve the bending behavior of the cable and a thin serving of the inner element. They preferably consist of polystyrene.

The document CH-257 548 discloses a coaxial cable (FIG. 2), in which a hollow inner conductor is kept at a distance and insulated from the outer conductor by a number of tubes of ethylene polymer wound spirally in a single layer. The diameter of the tubes is chosen to be as great as possible, in order to provide as little solid material as possible between the inner conductor and the outer conductor. In order to obtain the necessary hold for the inner conductor, the tubes are produced with oversize, and their cross section is deformed from the circular cross section to such an extent that the desired diameter ratio is obtained and the necessary pressure is exerted on the inner conductor.

The document DE-A1-199 56 641 describes a coaxial cable in which the inner conductor is separated from and supported against the outer conductor by a number of strands, preferably formed as monofilaments. The strands comprise as dielectric material polyether ether ketones, polyaryl ether ketones or polyether imides. Here, only the intermediate spaces between the strands are air-filled.

The document DE-C-902 865 discloses a coaxial cable in which tubes of insulating material, for example polyethylene, are wound around the inner conductor as spacers and a wrapping of plastic is also applied on top. Tubes of originally round cross section are used and are pressed together in the radial direction onto the inner conductor under the tension occurring during the stranding and by the subsequent wrapping, so that they lie very closely against one another and thereby assume an approximately sector-shaped form in cross section.

A further document, GB-535,743, is directed to a coaxial cable in which the inner conductor is surrounded by a number of tubes or cables of a material with low dielectric loss such as “polythene” or rubber.

The document GB-A-2 374 721 discloses a coaxial cable in which a hollow inner conductor is surrounded by a multiplicity of filamentary insulating strands, which are aligned parallel to the inner conductor. The strands, which are preferably of methyl pentene, are distinguished by high elastic loading under tension in the longitudinal direction, and serve for improving the mechanical properties of the cable.

Finally, JP-A-7169341 discloses a radiation-resistant coaxial cable in which the intermediate space between the inner conductor and the outer conductor is filled with glass fibers or ceramic fibers.

With regard to a minimal temperature-dependent phase change, solutions with a special construction of the dielectric are known (U.S. Pat. No. 4,287,384), as well as solutions (U.S. Pat. No. 3,909,555 or U.S. Pat. No. 3,971,880) in which the inner conductor consists of a metal of low thermal expansion coated with a layer of good conductivity. In the latter case, the dielectric consists of finely divided quartz, magnesia or alumina.

A known high-quality coaxial cable is the coaxial cable offered by the applicant of the type “SUCOFLEX 404”. This coaxial cable with an impedance of 50 ohms, an operating frequency of 26.5 GHz and an outside diameter of 5.5 mm has an attenuation at 25.6 GHz of approximately 1.15 dB/m. The (non-linear) phase change in the temperature range between −55° C. and +125° C. is only 750 ppm. The inner conductor, consisting of silverplated copper, is surrounded here by an extruded PTFE dielectric of ultra low density, which has a relative dielectric constant of 1.26. The non-linear profile of the phase change with temperature results from the non-linear temperature dependence of the portion of the phase change that is caused by the dielectric constant of the PTFE. According to the findings of the inventors, the low absolute amount of the phase change is attributable to the negative temperature-related response of the portion of the phase change that is caused by the dielectric constant of the PTFE being compensated in large part by the positive temperature-related response of the portion of the phase change that is caused by the thermal expansion of the inner conductor and the outer conductor.

Although the “SUCOFLEX 404” coaxial cable described has extremely good properties with respect to attenuation, temperature-dependent phase change and operating range, there is nevertheless the desire to improve such a cable further in all values. In particular, the cable improved in this way is intended to be sufficiently flexible, comparatively simple and inexpensive to produce and also have good quality in cases of small diameters in the millimeter range.

### SUMMARY OF THE INVENTION

The invention is therefore based on the object of providing a flexible or semi-flexible coaxial cable which avoids the disadvantages of the known coaxial cables. The cable is intended in particular to be distinguished by minimal attenuation. Furthermore, it is intended to have a minimal temperature-related response of the phase shift. In addition, the dependence of the phase shift on temperature should be as linear as possible over a great temperature range. Finally, it is intended that the cable can be used without any problem even under aggravated conditions, in particular in space and within a great temperature range from at least −55° C. to +125° C., and allow itself to be produced comparatively simply down to small outside diameters of a few (for example 6) millimeters.

The object is achieved by the features of claim 1 as a whole.

For the coaxial cable according to the invention, it is essential that the dielectric between the inner conductor and the concentric outer conductor is made up of a plurality of hollow fibers consisting of a glass and running in the longitudinal direction of the cable, and that at least the inner conductor has a coefficient of thermal expansion which is made to match the dielectric with regard to a temperature-related phase change in the coaxial cable that is as small as possible.

Hollow fibers drawn from glass can be produced or drawn very uniformly down to outside diameters of less than 1 mm and wall thicknesses of less than 0.05 mm. At these dimensions, such hollow glass fibers or glass capillaries have a high mechanical stability and at the same time can bend within wide limits without breaking. The hollow glass fibers are strong under tension and can be stranded without difficulty, and can thus be integrated in conventional cable production processes. In particular, coaxial cables provided with hollow glass fibers as a dielelectric are insensitive to high and low temperatures, vibrations and other mechanical effects. The hollow spaces in the hollow fibers and between the hollow fibers can, if need be, be evacuated over the entire length of the cable or filled with special gases or gas mixtures, if this is desired or required in certain applications.

The hollow glass fibers are good electrical insulators and chemically neutral or comparatively insensitive to external effects. Because of the small possible wall thicknesses, they create a dielectric which has a great porosity, and consequently a high air content. In particular, the portion of the temperature-related response of the phase change that is caused by the hollow glass fibers is linear and, depending on the type of glass, may be close to zero.

One configuration of the coaxial cable according to the invention is characterized in that the portion of the phase change caused by the dielectric has an almost negligible temperature-related response, and in that the coefficient of thermal expansion of the inner conductor is correspondingly approaching zero. Preferably, the coefficient of thermal expansion of the outer conductor is also approaching zero. This allows the temperature-dependent phase changes to be kept very low over a wide temperature range, the remaining temperature dependence being largely linear.

Another configuration of the invention is distinguished by the fact that the hollow fibers are arranged in a number of concentric layers. In this case, an intermediate layer, in particular of an electrically insulating material, preferably a plastic, is preferably provided respectively between the concentric layers of the hollow fibers and increases the stability of the cable construction. The mechanical properties are further improved if the hollow fibers of the individual concentric layers are respectively stranded, it being possible for the stranding to be in the same direction or in opposite directions from layer to layer.

In principle, the entire dielectric may be made up of hollow fibers of one type. However, greater flexibility in the design of the cable is achieved by the hollow fibers of different concentric layers being designed differently in their construction and/or material and/or their dimensions.

Hollow fibers which consist substantially of quartz glass or SiO2 have been found to be particularly favorable with respect to the electrical and mechanical and processing properties, hollow fibers with a circular cross section and an outside diameter of between 0.01 mm and 4 mm, in particular between 0.01 mm and 1 mm, being preferred. The hollow fibers in this case have a wall thickness of between 0.001 mm and 2 mm, in particular between 0.001 mm and 0.05 mm.

Particularly good long-term stability of the coaxial cable can be achieved by the hollow fibers being provided on the outside with a protective covering layer, which preferably consists of an acrylate or silicone or a ceramic or a fluorinated ethylene propylene (FEP) or polyethylene and has a layer thickness in the range of 10 μm.

Since the effect of the dielectric of hollow glass fibers on the temperature-dependent phase change is comparatively small in comparison with conventional dielectrics, such as for example PTFE, an inner conductor which has a coefficient of thermal expansion of less than or equal to 5 ppm/K is preferably used in the coaxial cable. In particular, the inner conductor consists of FeNi36Ag (“Invar”) or Kovar or glass and is provided on the outside with a cladding layer of good electrical conductivity, in particular of Ag. The inner conductor advantageously has in this case an outside diameter of less than 2 mm.

By contrast, the outer conductor may comprise a wound CuAg strip.

### BRIEF DESCRIPTION OF THE DRAWINGS

The invention is to be explained in more detail below on the basis of exemplary embodiments in conjunction with the drawing, in which:

FIG. 1 shows the basic construction of a coaxial cable according to an exemplary embodiment of the invention in cross section;

FIG. 2 shows the stranding of the layers of hollow fibers of the coaxial cable as shown in FIG. 1 in a perspective view;

FIG. 3 shows the cross section of a prototype of the coaxial cable according to FIG. 1 in a photo;

FIG. 4 shows the construction of the inner conductor of the coaxial cable from FIG. 1 in a simplified representation, as a core of adapted thermal expansion provided with a conductive cladding layer;

FIG. 5 shows the construction of a hollow fiber of the coaxial cable from FIG. 1 in a simplified representation, as a hollow glass fiber provided with a protective covering layer;

FIG. 6 shows a diagram of the temperature dependence of the phase change Δp in a coaxial cable with a portion caused by a dielectric of acrylate-coated hollow SiO2 fibers (curve a1) and a portion caused by a CuAg inner conductor (of silverplated copper) (curve b1); and

FIG. 7 shows a diagram of the temperature dependence of the phase change Δp in a coaxial cable with a portion caused by a dielectric of acrylate-coated hollow SiO2 fibers (curve a1) and a portion caused by a silverplated FeNi36Ag inner conductor (of “Invar”) (curve b2).

### DESCRIPTION OF PREFERRED EMBODIMENTS

The great porosity necessary for low attenuation, with the resultant high air content, is achieved in the prior art, for example, by a high degree of foaming. At present, PTFE is predominantly used to achieve this property, as is the case with the commercially available coaxial cable described at the beginning of the type “SUCOFLEX 404”. However, as a result of the high degree of foaming or the associated porosity, the mechanical stability decreases. A cross-sectional insulator profile with lowest possible material content or high air content can today also be achieved by means of profile extrusion; however, there are limits to this with respect to porosity (60-80%) and mechanical stability.

In the case of the present invention, the required properties are achieved by choosing hollow fibers of a glass. Using hollow glass fibers allows the air content to be increased considerably, while the mechanical properties are particularly good if a suitable glass is used. Moreover, such technology allows more cost-effective production in comparison with extrusion, because faster processing is possible. The use of hollow fibers preferably of quartz or silica or SiO2 allows a dielectric with good strength and very good porosity of about 92% to be achieved. In this case, SiO2 has very good properties with respect to the thermal expansion and the electrical values.

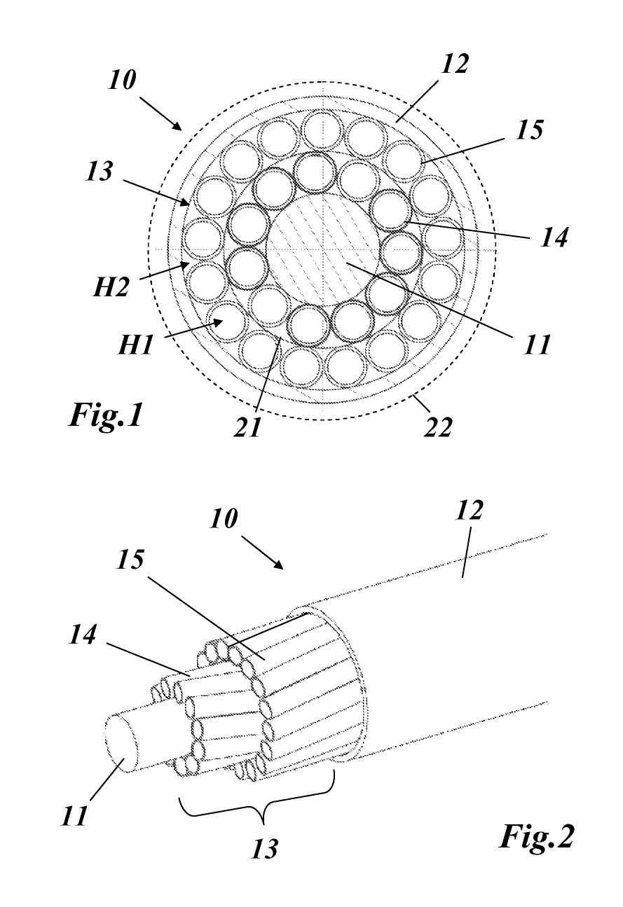

In FIG. 1, the basic construction of a coaxial cable according to an exemplary embodiment of the invention is reproduced in cross section; FIG. 2 shows the stranding of the layers of hollow fibers of the coaxial cable as shown in FIG. 1 in a perspective view. The coaxial cable 10 of FIGS. 1 and 2 comprises a central inner conductor 11, which is concentrically surrounded by an outer conductor 12 at a specified distance. The annular intermediate space between the inner conductor 11 and the outer conductor 12 is filled by a dielectric of high porosity, i.e. a high proportion of air-filled hollow spaces H1 (within the hollow fibers) and H2 (between the hollow fibers). The arrangement of conductors is surrounded on the outside by an insulating, protective jacket 22 (indicated in FIG. 1 by dashed lines).

The dielectric comprises standard hollow fibers 14, 15, which are arranged into layers arranged concentrically one within the other. The hollow fibers 14 of the inner layer and the hollow fibers 15 of the outer layer are in themselves stranded. The stranding according to FIG. 2 is a so-called SZ stranding (i.e. oppositely running layers of stranded hollow fibers). However, a “unilay” stranding (orientation of layers in the same direction) is alternatively also possible. Furthermore, it is possible to use a different type of fiber (fiber material, diameter, wall thickness) for each layer level. Further possibilities for variation are the setting of the pitch (length of lay), which may also be different for each of the layers. The number of layers is not restricted. It may also be advantageous to make the pitch vary arbitrarily in the stranding operation with +/−10% of the stranding length. A boundary condition is that the dimension of the dielectric, comprising N layers of stranded hollow fibers, gives a defined impedance value (typically 50 or 75 ohms).

When stranding, it is also necessary to keep an eye on the respective requirements for the final product: for example, torsional stability, temperature stability, electrical properties of the cable (phase stability, attenuation, power transmission).

Between the individual layers of the stranded hollow fibers 14, 15 there may be introduced (concentric) intermediate layers 21, which likewise consist of insulating material (for example plastic). The intermediate layer 21 may in this case be introduced by extrusion, cross-wrapping, longitudinal wrapping or dip coating.

The diameter for the individual hollow fiber 14, 15 (d2 in FIG. 5) lies in the range from 0.01 mm to 4 mm, in particular in the range between 0.01 mm and 1 mm. A diameter that can be given by way of example is 650 μm. The wall thickness of the hollow fibers 14, 15 lies in the range between 0.001 mm and 2 mm, in particular between 0.001 mm and 0.05 mm. A wall thickness that can be given by way of example is 27 μm. The individual hollow fibers 14, 15 may be strengthened with respect to one another or not strengthened. This has an influence on the mobility of the entire cable construction and may be of advantage in some applications after installation of the cable. The outside diameter of the dielectric lies in the range between 0.03 mm and 12 mm. The outside diameter of the coaxial cable 10 is governed by the construction of the outer conductor 12 and lies between 0.05 mm and 16 mm.

The materials from which the hollow fibers 14, 15 could be produced are insulating, non-conducting materials. Although plastics (fluoropolymers, polyethylene, polypropylene, COC, TPX, COP, PVC) may also be used as hollow fiber materials, in principle the hollow fibers consist of a glass, in particular quartz glass or silica, but also ruby or other gemstone glass or materials. However, combinations of all these materials are also conceivable. In addition, it may be advantageous to produce the hollow fibers 14, 15—in the way shown in FIG. 5—from a number of concentric layers 18, 19 of the two aforementioned classes of material, that is to say for example a hollow quartz glass fiber or hollow fiber 19 which is provided on the outside with a thin (for example 10 μm thick), protective covering layer 18, for example of a fluoropolymer (in particular FEP). A further possibility is to use porous hollow fibers or microstructured fibers or hollow fibers with non-round cross sections or special cross-sectional contours.

It is also important within the scope of the invention to choose a suitable material for the inner conductor 11 and the outer conductor 12, with a coefficient of thermal expansion made to match the dielectric 13. Depending on the temperature-related response of the portion of the phase shift caused by the dielectric, the coefficients of expansion are chosen for the purposes of compensation to be both positive or both negative, or else equal, or approximately equal to zero. This produces an optimum phase response over temperature, because:

1. a temperature change leads to a change in the (relative) dielectric constant (∈ᵣ) of the dielectric 13, and consequently to a change in the electrical length and, as a result, a phase shift results when there is a temperature change, and

2. a temperature change of the inner conductor 11 and the outer conductor 12 produces a phase shift associated with the change in length that is opposite in comparison with the effect in the case of the dielectric 13.

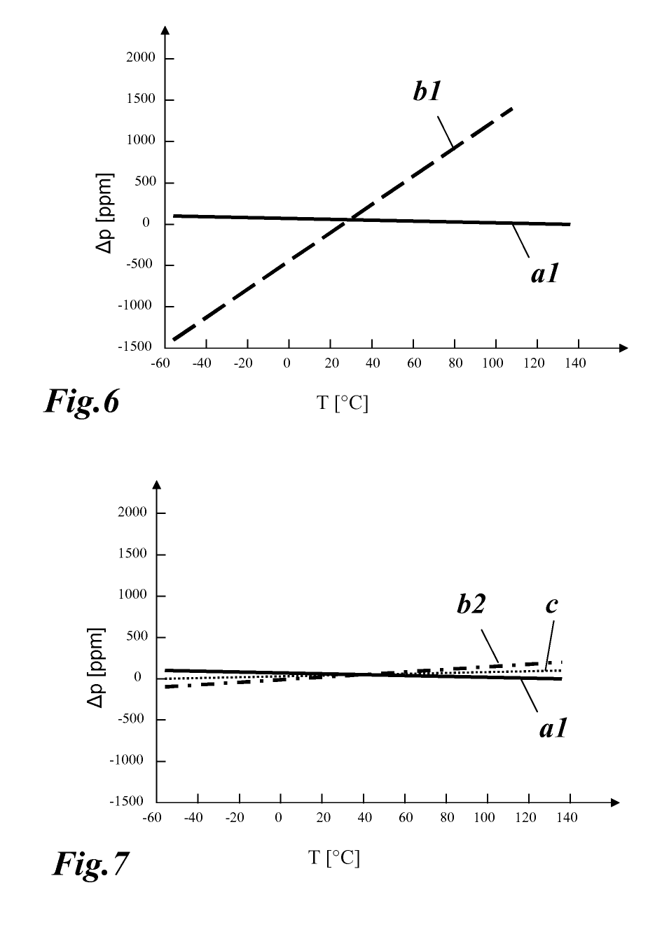

The sum of the two effects gives the overall (optimal) phase change with lowest attenuation values (because of the high porosity). If the dielectric 13 contributes only little to the temperature-dependent phase change Δp, as is the case with hollow fibers of glass and is characterized in FIGS. 6 and 7 by the curve a1, compensation by the inner conductor and outer conductor is not necessary. Rather, it is then necessary for the inner conductor 11 especially, but also the outer conductor 12, to have a coefficient of thermal expansion that is as low as possible or negligible (curve b2 in FIG. 7), that is to say to be made, for example, of Invar, Kovar or similar materials in terms of thermal expansion. In order at the same time to achieve the required high electrical conductivity, the inner conductor 11 according to FIG. 4 comprises a core 16 of this material and is provided with a cladding layer 17 of Ag or the like. Superposing the two curves a1 and b2 then gives as the net effect the curve c, which more or less symbolizes a temperature-independent phase shift. If, on the other hand, instead of FeNi36Ag (Invar), a silverplated Cu conductor (CuAg) is used as the material for the inner conductor 11, this produces—as shown in FIG. 6-a portion of the temperature independent phase change that is comparatively great according to curve b1 shown there, and leads altogether to a correspondingly strong temperature response. In both cases, however—unlike in the case of PTFE as the dielectric—at least a linear temperature-related response is achieved.

The outer conductor 12 may comprise a cross-wound metal strip or a metallized strip or a metallized film. It may also be formed as a longitudinal film, consisting of metal or metallized strip/film, a braiding of wire, litz wires or metallized fibers of insulating material. It may, however, also comprise a combination of all these types of outer conductors.

The jacket 22 may comprise a layer of insulating material or plastic, a cross-wound strip or a film of insulating material, a longitudinal film of insulating strip or film, a braiding of fibers of insulating material, or combinations of these types of jacket.

### Example

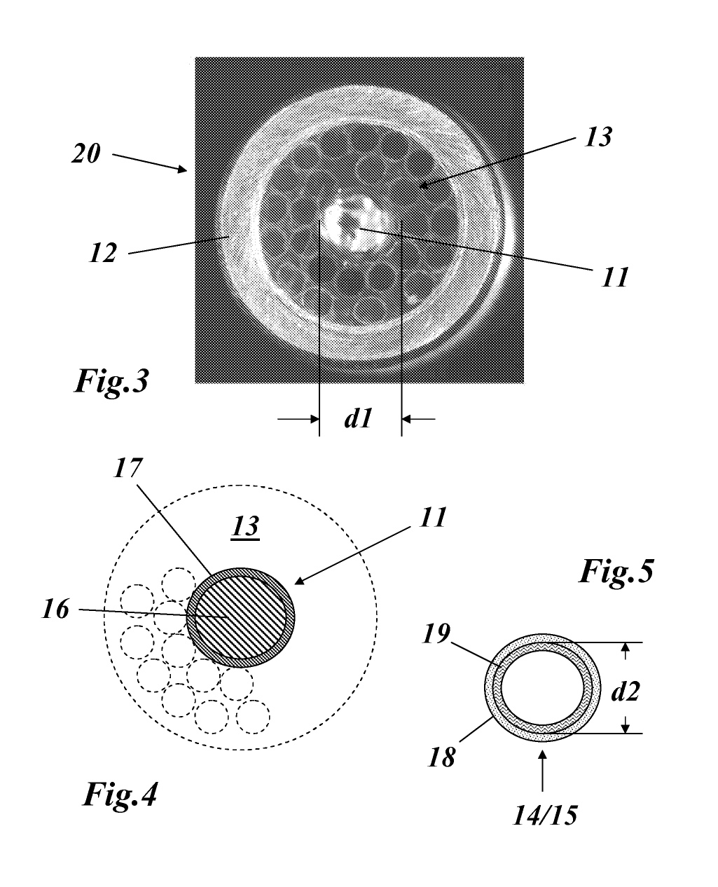

A prototype (20) of the coaxial cable according to the invention, which is shown in FIG. 3 and has the following data, was produced:

Inner conductor: Ag-coated copper conductor (diameter d1=1.7 mm)

Hollow fiber: quartz glass, 27×650 μm; 25 fibers in two layers

Outer conductor: wound CuAg strip

Dielectric constant (∈ᵣ): 1.22

Attenuation at 18 GHz: 3.1

Attenuation at 26.5 GHz: 4.5

Phase change: 3600 ppm (linear) in the temperature range from −55° C. to +125° C.

The comparatively high temperature-dependent phase change in the case of this prototype can, however, be reduced drastically (to 90 ppm) if the inner conductor 11 consists of silverplated FeNi36Ag (Invar), and consequently has virtually negligible thermal expansion:

1. A coaxial cable (10, 20) comprising:
a central inner conductor (11) concentrically surrounded by an outer conductor (12) at a specified distance, an intermediate space between the inner conductor (11) and the outer conductor (12) filled with a dielectric (13), wherein the dielectric (13) is made up of a plurality of hollow fibers (14, 15, 19) comprising a glass and extending in a longitudinal direction of the cable, and in that at least the inner conductor (11) has a coefficient of thermal expansion which is made to match the dielectric (13) with regard to a temperature-related phase change in the coaxial cable (10, 20) that is as small as possible.

2. The coaxial cable as claimed in claim 1, wherein a portion of the phase change caused by the dielectric (13) (curve a1) has an almost negligible temperature-related response, and in that the coefficient of thermal expansion of the inner conductor (11) is correspondingly approaching zero (curve b2).

3. The coaxial cable as claimed in claim 2, wherein the coefficient of thermal expansion of the outer conductor (12) is also approaching zero.

4. The coaxial cable as claimed in claim 1, wherein the hollow fibers (14, 15, 19) are arranged in a number of concentric layers.

5. The coaxial cable as claimed in claim 4, further comprising:
an intermediate layer (21), in particular of an electrically insulating material is provided respectively between the concentric layers of the hollow fibers (14, 15).

6. The coaxial cable as claimed in claim 4, wherein the hollow fibers (14, 15, 19) of the individual concentric layers are respectively stranded.

7. The coaxial cable as claimed in claim 4, wherein the hollow fibers (14, 15) of different concentric layers are designed differently in their construction and/or material and/or their dimensions.

8. The coaxial cable as claimed in claim 1, wherein the hollow fibers (14, 15, 19) consist substantially of quartz glass or SiO2.

9. The coaxial cable as claimed in claim 8, wherein the hollow fibers (14, 15, 19) include a circular cross section and an outside diameter of between approximately 0.01 mm and approximately 4 mm.

10. The coaxial cable as claimed in claim 8, wherein the hollow fibers (14, 15, 19) include a wall thickness of between approximately 0.001 mm and approximately 2 mm.

11. The coaxial cable as claimed in claim 8, wherein the hollow fibers (14, 15, 19) are provided on the outside with a protective covering layer (18).

12. The coaxial cable as claimed in claim 11, wherein the covering layer (18) comprises one of an acrylate, silicone, a ceramic, a fluorinated ethylene propylene (FEP), and polyethylene (PE) and includes a layer thickness in the range of approximately 10 μm.

13. The coaxial cable as claimed in claim 1, wherein the inner conductor (11) has a coefficient of thermal expansion of less than or equal to approximately 5 ppm/K.

14. The coaxial cable as claimed in claim 13, wherein the inner conductor (11) comprises one of FeNi36Ag, Kovar, and glass and is provided on the outside with a cladding layer (17) of good electrical conductivity and in that the inner conductor (11) has an outside diameter of less than approximately 2 mm.

15. The coaxial cable as claimed in claim 1, wherein the outer conductor (12) comprises a wound CuAg strip.
